(19) United States
(12) Patent Application Publication
(10) Pub. No.: US 2002/0056690 A1
(43) Pub. Date: May 16, 2002

(54) Apparatus and process for treating manure

(76) Inventor: Paul Wegner, San Carlos, CA (US)

Correspondence Address: BENASUTTI, P.A., 17294 BERMUDA VILLAGE DRIVE, BOCA RATON, FL, 33487, US

(21) Appl. No.: 09/955,770

(22) Filed: Sep. 18, 2001

Related U.S. Application Data
(60) Provisional application No. 60/233,793, filed on Sep. 19, 2000.

(51) Int. Cl. B01D 17/038

(52) U.S. Cl. 210/773; 210/787; 210/804; 210/805; 210/198.1; 210/259; 210/512.1

(57) ABSTRACT

An apparatus and method are disclosed for washing manure to remove undesirable elements and produce environmentally desirable processed manure solids and a manure tea by-product. The apparatus is arranged so that the manure, which is transformed into a slurry, passes through the apparatus vertically by gravity during the washing process. The process includes the addition of most preferably nitric acid or alternatively iron salts; and a polymer.

### CROSS REFERENCE TO RELATED APPLICATIONS

This application is a continuation-in-part of my prior co-pending provisional Patent Application No. 06/233,793, filed Sep. 19, 2000; the disclosure of which is incorporated herein by reference, as if fully set forth.

### BACKGROUND OF THE INVENTION

1. Field of the Invention

This invention relates to the treatment of manure to remove environmentally undesirable products such as salts and in particular to the treatment of cattle manure and the recovery of useful bi-products.

2. Description of the Prior Art

Animal manure is considered a hazardous waste because of its high salt content. The high salinity of cattle manure causes buildup of salt in the ground and ground water. The increase in salinity makes the land unacceptable for growing plants and the ground water unacceptable for drinking. As far as plants are concerned, sodium and chloride followed by high Total Dissolved Solids (TDS) are the main elements that cause plant stress in terms of high salinity. High levels of sodium are the most troublesome.

Manure is difficult to wash, because there are natural emulsifiers present which make the separation of the suspended solids from dissolved materials, such as salt, difficult. When water is added to manure, a muddy suspension is formed. The suspended solids rapidly blind filters.

In terms of patent prior the closest to actually practicing sodium removal is U.S. Pat. No. 4,755,206 which discloses washing the soil in place. It makes no attempt to collect the waste brine water.

U.S. Pat. Nos. 5,776,350 and 5,785,730 use polymers to improve separation of a liquid from solid agricultural waste materials.

U.S. Pat. No. 5,593,600 discusses mechanically separating sand, salt and organic waste with a hydro cyclone.

Other patents also teach the use of polymers to coagulate the manure.

Many industries, such as mining, use processes or machinery capable of continuous leaching. They usually consist of a moving filter belt assembly or series of shallow pans with screen bottoms. Another approach consists of a rotating disk and stationary disk module to prevent channeling and to allow flow through a counter-current flow bed. All these machines involve moving parts and components that are prone to clogging.

Clogging is usually dealt with by an approach called cross-flow filtration in which the solids slurry flow runs parallel to the filter screen plane. The flow of the slurry across the surface of the screen washes off an area; which has built up in solids and blinds. This approach precludes the possibility of the counter-current flow washing, because the unwashed solids are constantly being mixed with washed solids.

If one attempts to wash cattle manure with conventional flow through equipment, the flow rate is too slow for practical industrial scale production. In addition, wash processes which have an adequate flow rate require that the process be batched in nature, rather than continuous.

In the case of cross-flow washing, the washing fluid flows in the same direction as the solids and perpendicular to the plane of the filtration surface. Clog prevention in the case of cross-flow filtration depends upon high velocity of the solids slurry/wash water sweeping blinded areas on the surface of the filter plane being swept off the surface. The action is similar to a fast flowing river that sweeps the slit down to the delta region of river, while the water slowly oozes through the river bottom and into the ground water table. Cross-flow filtration washing is unacceptable in this case, because to achieve the required fluid velocities, the required surface area of the filter membrane would be too high. Also the washing efficiency at such high fluid velocities would be poor. In addition, the high velocities could lead to channeling and uneven flow distribution.

Cattle manure, even in water, compacts under its own weight very easily. Even a 24″ bed of cattle manure slurry will compact and blind; preventing any significant flow of water through the slurry. Shallower beds work better, but once a significant flow is introduced through the bed, the flow ceases due to the action of compaction from gravity and flow. If the flow is run from bottom to top in order to neutralize the influence of gravity and flow by creating a quick sand style bed, channeling ensues and nonuniform washing results.

Very shallow trays (5″ deep) with screen bottoms and spray bars to introduce fresh wash water, yield acceptable results. However, the machinery required to move these trays or a conveyor belt style filtration bed system to produce a continuous process, are complex, expensive, and require significant maintenance. (See Perry's Chemical Engineering Handbook). Normal separation processes are described in paragraphs 17-52 and cross-flow filtration in paragraphs 17-51. Selection or design of leaching processes is described in paragraph 19-51 and the area filtration in paragraph 19-67. Scale tests are described in paragraphs 19-69. See also FIG. 19-81 for washing effectiveness and equations 19-38.

It is desirable to remove most of the salt from the manure rapidly and generate little waste brine.

It is desirable to coagulate the suspended solids in order to separate the wash water from the manure solids.

It is also desirable to increase the permeability of the solids such that the wash water may pass rapidly through manure solids and remove most of the salt, while generating the least amount of waste brine. In order for the wash process to be commercially practical, the wash process should be continuous, efficient, reliable and rapid.

It is also desirable to strip as much sodium from the manure as possible.

It is also desirable for the processed manure to be a good soil amendment or fertilizer.

It is also desirable for the salt brine wash product to be a saleable product.

It is also desirable to produce a low moisture solid manure product.

### SUMMARY OF THE INVENTION

The invention essentially consists of three basic improvements. The first is adding chemicals to make the cattle manure washable at all. The second improvement is the development of an apparatus and method whereby rapid, continuous, efficient washing is possible. The third is the use of chemicals that simultaneously make the manure washable and add to the fertilizer value of the manure and brine.

Also, I have designed a gravity driven system with the exception of conveying the manure to the top of a reactor module and pumping of the washed solids to a centrifuge.

An aspect of the invention is the unique design of the wash module, which allows for the rapid washing of salt from cattle manure on a continuous basis.

Another aspect is the unique blend of chemical additives, which dramatically increase the permeability of the manure without the addition of materials that add undesirable chemicals to the processed manure. These chemicals also aid in the removal of the sodium ion; which is particularly difficult to remove from the manure. The sodium ion increases the salt burden on the soil when the manure is applied to the fields as a soil amendment or fertilizer. The sodium ion causes plant stress and eventually makes the land unacceptable for growing plants. It also can run off the land and contaminate ground water, rivers, and other fresh water supplies, making these sources unacceptable for potable water uses.

The wash module can be distinguished from column flow washing, fluidized bed washing and cross-filtration washing in the manner described below. I am defining this new wash approach as orthogonal flow washing.

My invention comprises a method of washing manure to remove undesirable elements and produce environmentally desirable processed manure solids, comprising the steps of:

a. pulverizing the manure;

b. mixing the pulverized manure with a liquid comprising at least nitric acid and a polymer, to form a slurry;

c. washing the slurry with brine and water to remove environmentally objectionable levels of salt;

d. collecting and centrifuging the washed slurry; and

e. collecting processed manure solids from the centrifuging process.

It further comprises the additional step of performing at least the steps b. through d. of by using gravity to move the manure.

I collect the liquid from the centrifuge and use it as the brine introduced in the washing process and use it as a by-product for agricultural purposes.

In my method, I remove brine from the washing process and introduce it as part of the liquid mixture with the nitric acid and polymer.

The polymer is first mixed with water in a ratio of approximately one part polymer to 99 parts water.

In accordance with my invention, I provide an apparatus for washing manure to remove undesirable elements and produce environmentally desirable processed manure solids, comprising:

a. pulverizing means to pulverize the manure;

b. mixing means to mix the pulverized manure with a liquid comprising at least nitric acid and a polymer, to form a slurry;

c. washing means to wash the slurry with brine and water to remove environmentally objectionable levels of salt from it;

d. collecting means to collect the washed slurry;

e. centrifuging means to centrifuge said washed slurry and produce processed solids and liquid by-product; and

f. collecting means to collect the processed manure solids from the centrifuging process; arranged so that the manure and slurry passes therethrough by gravity.

The washing means has means for passing the brine and water through the slurry in an orthogonal flow.

Removal means are provided for removing brine from the washing means and introducing it as part of the liquid having the nitric acid and polymer.

Mixing means are provided to mix the polymer with water in a ratio of approximately one part polymer to 99 parts water and supply it to the mixing means of element b.

Return means are provided to return a portion of the liquid by-product produced by the centrifuging means of element e., to the washing means of element c.

Fresh water means are provided to introduce fresh water into the washing means of element c.

The washing means of element c. comprises a container having a plurality of screen pairs therein.

The screen pairs comprise envelopes and said pairs are so spaced that slurry may be introduced between the pairs for washing of the slurry.

The screen pair envelopes have vertically extending faces arranged such that the uppermost portions thereof are spaced closer to each other than the lower portions thereof.

The screen pair envelopes have vertically extending spaced apart faces and between said faces are horizontally extending partitions.

The fresh water means communicates with the lower third of at least some screen pairs to introduce the fresh water.

The means for passing the brine and water is connected to the washing means and screen pair envelopes in such a manner that the brine passes through the envelope above a partition and the water passes through the envelope below that partition.

### BRIEF DESCRIPTION OF THE DRAWINGS

FIG. 1 is a perspective view of an apparatus for treating manure in accordance with the preferred embodiment of my invention;

FIGS. 2A and 2B are enlarged cross sections of a portion of the apparatus shown in FIG. 1; partially exploded and reoriented;

FIG. 3 is an enlarged perspective view showing the arrangement of parts in a portion of the apparatus shown in the first three figures;

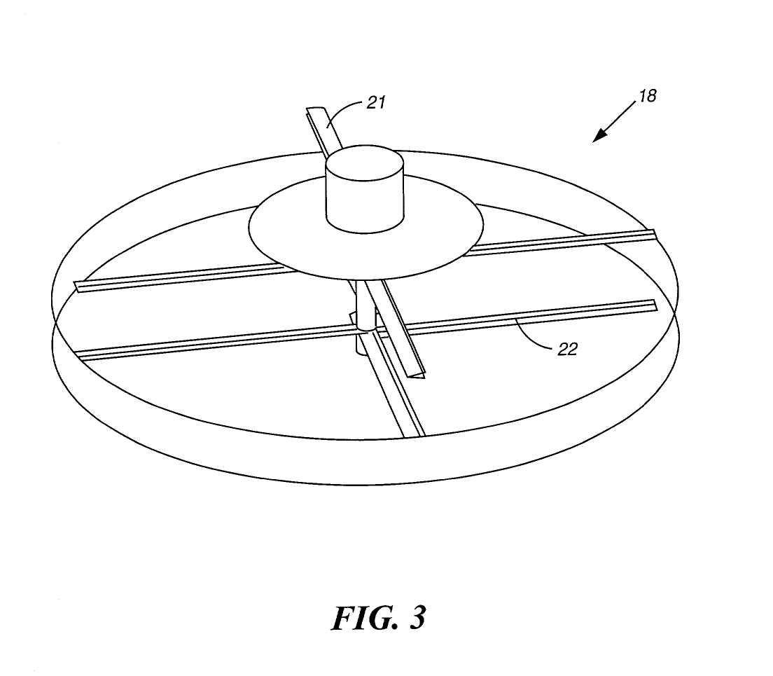

FIG. 4 is a detailed portion of the apparatus;

FIG. 5 is a schematic detail of a portion of the apparatus as particularly shown in FIGS. 1 and 2B;

FIG. 6 shows a flow chart in accordance with one embodiment of my invention;

FIG. 7 shows a schematic view of a portion of an apparatus in accordance with another embodiment of my invention;

FIG. 8 shows a schematic view of another portion of an apparatus in accordance with the embodiment shown in FIG. 7;

FIG. 9 shows a schematic view of a portion of an apparatus in accordance with the preferred embodiment of my invention; and

FIG. 10 shows a diagrammatic view of a portion of an apparatus in accordance with the preferred embodiment of my invention.

### DESCRIPTION OF THE PREFERRED EMBODIMENTS

### Process Overview

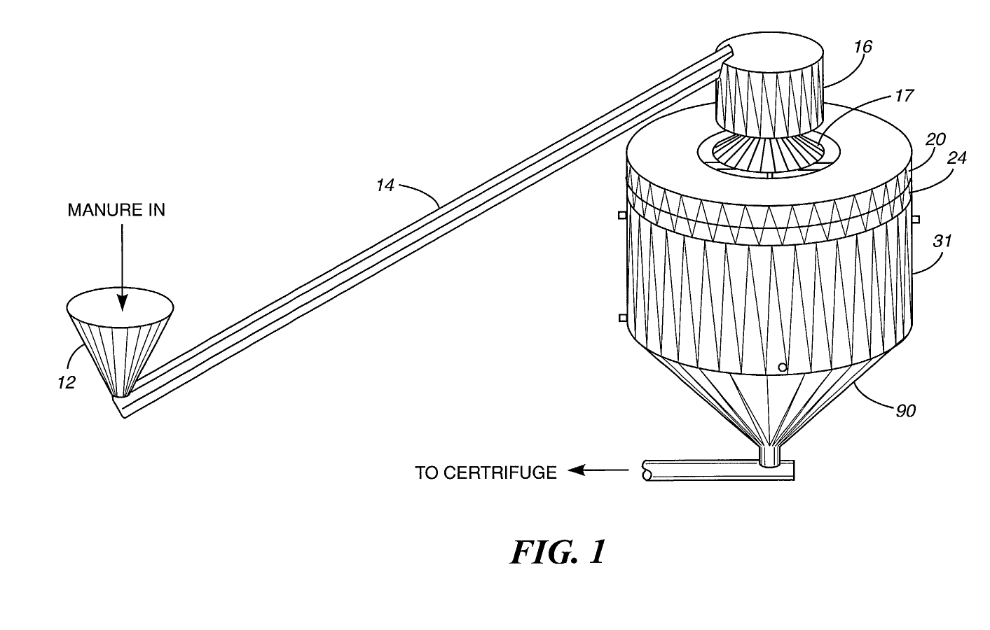

In mounds of raw manure, there will be thick clogs and foreign materials. The manure must first be screened to remove the foreign matter and break up the clods into a smaller particulate size. Once it is screened, the manure is dumped into a hopper 12 from which it is conveyed by an auger 14, FIG. 1, to a Jeffery hammer mill 16; which grinds up the manure to an even finer state. Most preferable, it forces it through one-quarter inch holes in a circular horizontal plate.

From there it drops by gravity on to a cone-shaped distributor 17 and then drops on to the surface 18 of a liquid 19. The liquid is retained in a cylindrical container 20, which I refer to as reactor module section 1. In that section, fan 21 rotates under the liquid. If iron salt is used in the process, it may be introduced through holes in the blades of the fan 21. However, nitric acid is preferred over iron salts; and may be introduced through the holes in the fan blades.

Additional fan blades 22 are positioned below the blades 21 to help distribute the salt over the whole area in the reactor module section 2.

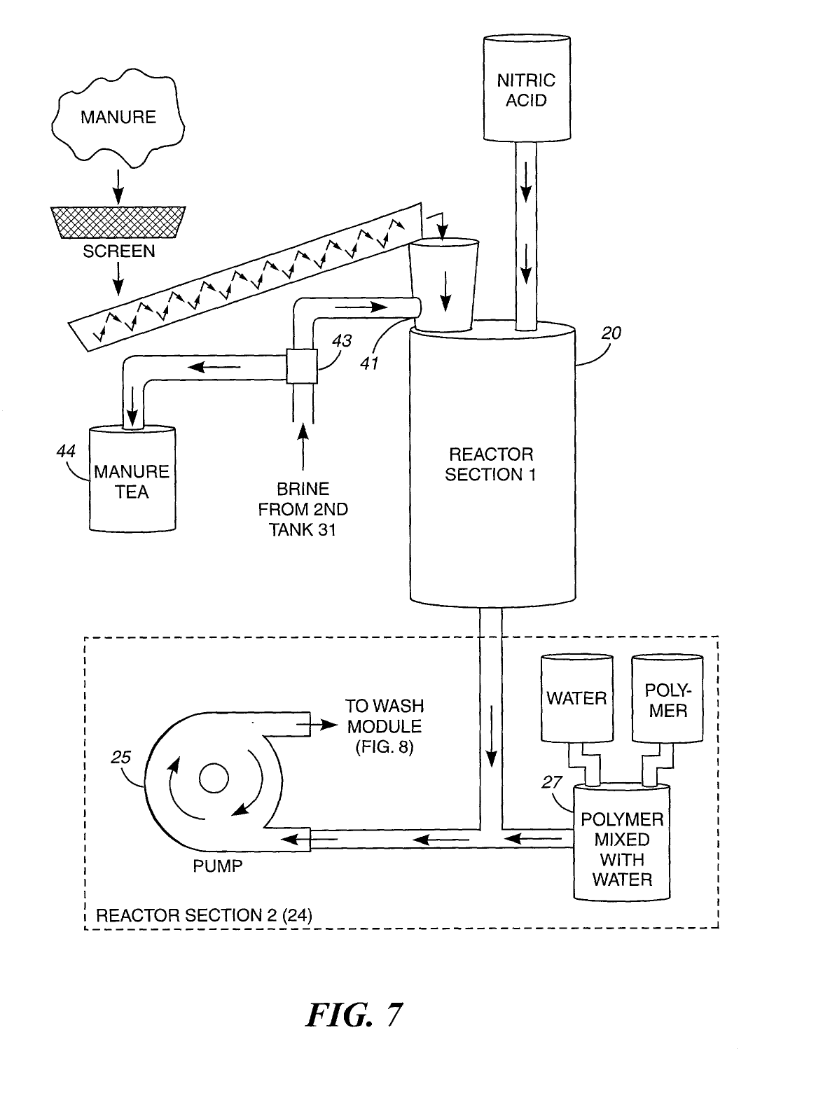

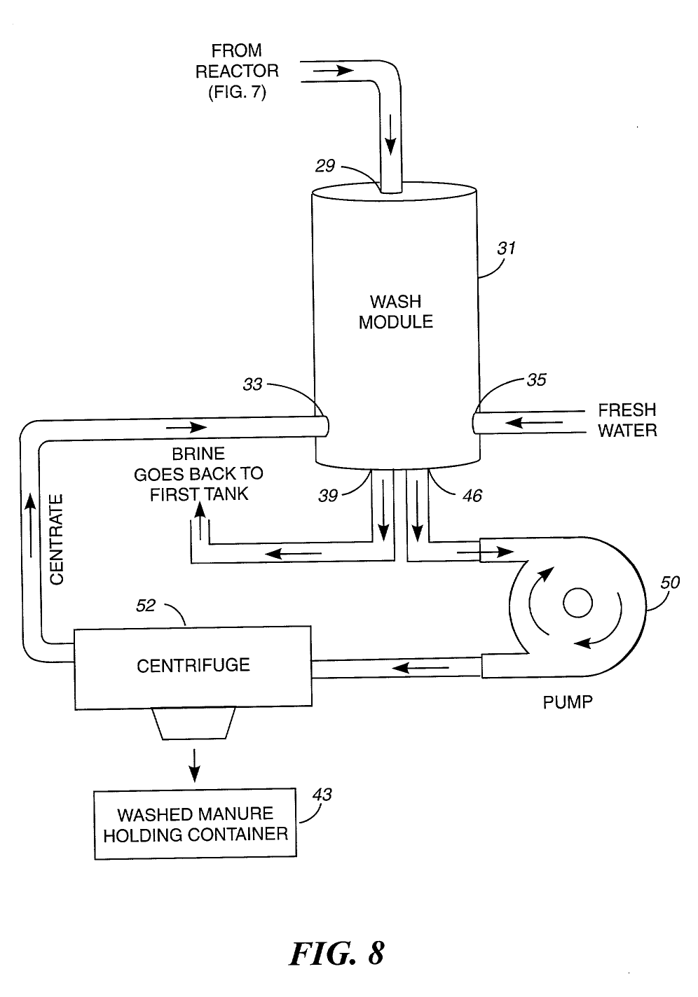

Perforated metal plates 23, preferably with ⅜ inch holes in them are positioned below the fans to promote even distribution of the solids. A polymer is introduced through holes in fan blades 22. The preferred polymer is “Optimer 7194” obtainable from Nalco Chemical Company. This second fan blade pair 22 is contained in what I call the reactor module section 2 designated 24. Module sections 1 and 2 (20 and 24) are shown in another embodiment, FIG. 7. In the embodiment shown in FIG. 7, a reservoir contains a mixture of polymer at 1% to fresh water at 99%. In the embodiment shown in FIG. 7, a parastolic pump 25 pumps the mixture together with a polymer from the reservoir 27 (as shown by the arrows). The polymer makes the mixture even more permeable to the flow of wash water. In that embodiment, the mixture is pumped up to the top 31 of the reactor wash module 31, FIG. 8.

However, it is preferred to use a gravitational system, as shown in FIG. 1. In the gravitational system, the reacted solids drop into module 31 via gravity.

Within the wash module 31, there are pairs of cylindrical screens; the first of which is positioned about one quarter of an inch away from the inside wall of the container 31. The manure, polymer, chemical and water mixture enters at 29 at the top of the wash reactor 31 and passes by gravity down through the large spaces between the pairs of screens. Fresh water is introduced through the tube 35 at the bottom. The fresh wash water migrates through cylindrical screens. Semi-salted water from the centrifuge 52 is also introduced at the bottom of the wash module 31 at 33, FIG. 8. As the manure solids are being washed and progress down through the tank 31, a brine is being drawn off at 39 and is being pumped back to the reactor first section 20 at 41; as make-up water. A part of this return brine leaves at 43 as manure tea. The manure tea is pumped to a manure tea brine tank 44 to be used as manure tea agricultural by-product.

The washed manure exits the bottom of the tank at 46, FIG. 8, and is pumped through pump 50 into centrifuge 52; where the liquid is removed as a semi-salted water; thence to be returned to the wash module 31 at 33. The finished fine processed manure solids are collected in the bin 54 below the centrifuge 52.

The waste brine generated from the wash module is divided into two streams. The first stream supplies the brine water to the reactor module at 41 to provide the proper manure solids to liquid ratio in the reactor module. The best ratio is about one part 50% moist manure solids to two parts water.

The second brine stream is the waste brine by-product stream. This product can be processed to produce products such as fertilizer or animal feed supplements.

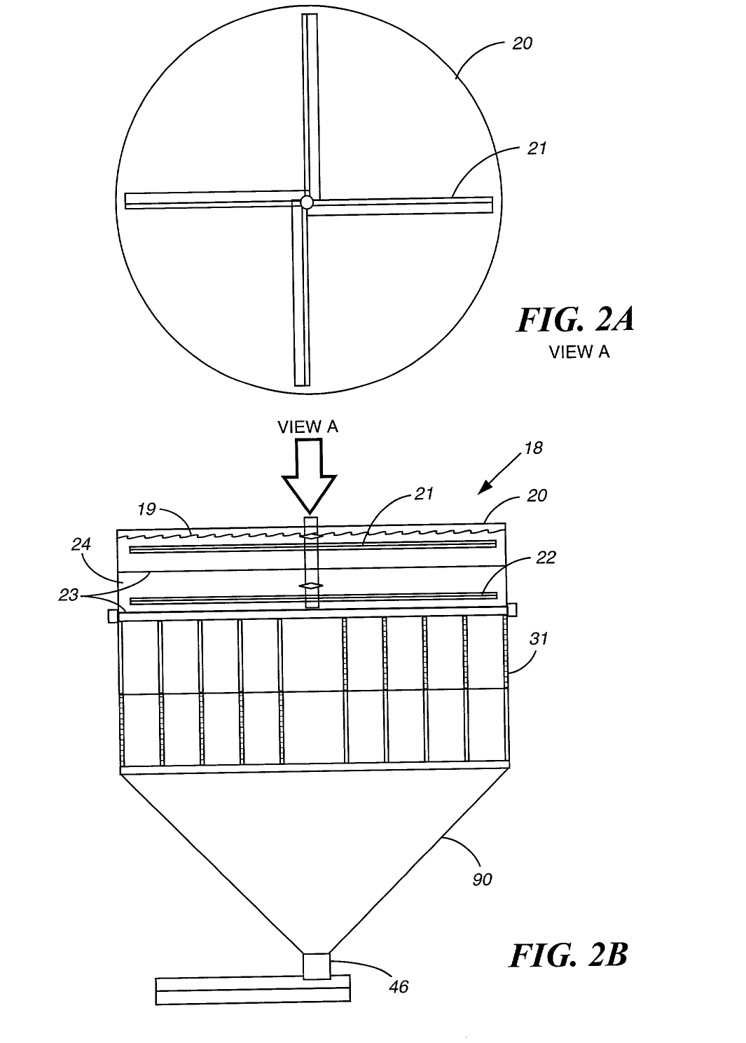

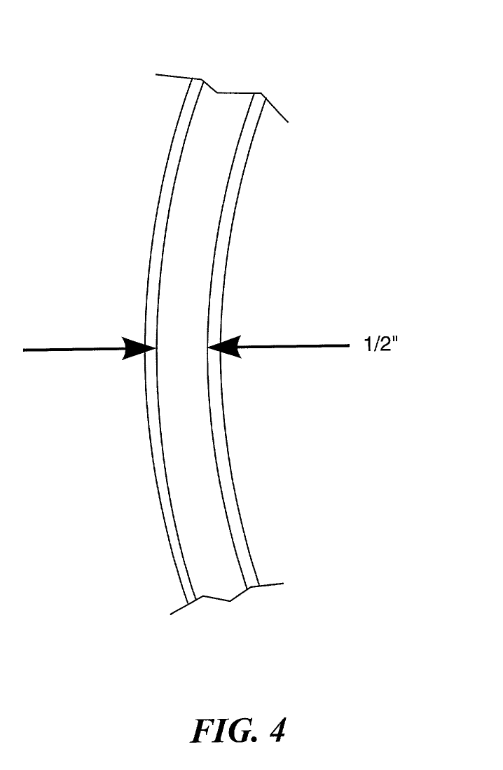

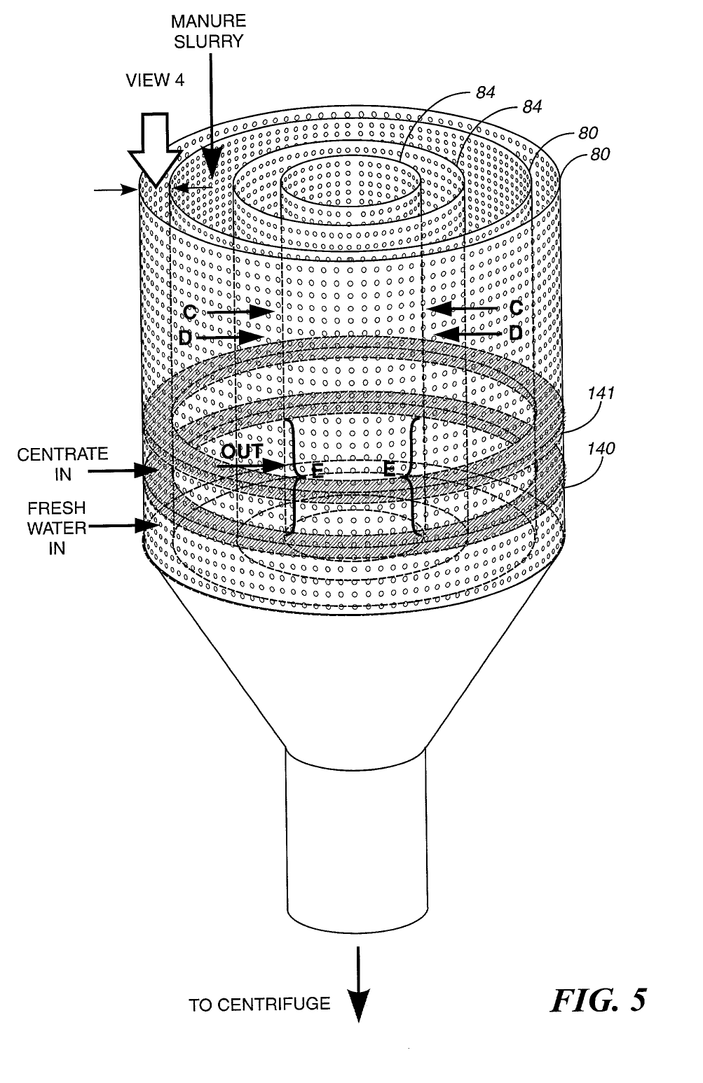

In accordance with the preferred embodiment of my invention, the wash module consists of multiple pairs of concentric perforated metal cylindrical screens as shown in FIGS. 2B and 5. One set of screen pairs acts as the distributor of input wash water consisting of both fresh water and brine. The set of screen pairs acts as collector of the wash water brine that has passed through the manure slurry. The manure is located between the distributor input wash water screen pair 80 and the output collector screen pair 84. The separation in between the screen pairs is very short (3″ to 6″; most preferably 4″). The cylinder pairs may be 1 to 8 ft. tall. The manure slurry progresses down the wash module in vertical fashion from top to bottom on a continuous basis, while the wash water progresses in generally horizontal fashion from the input distribution screen pair to the collector screen pair. See flow arrows C and D in FIG. 5. Water is introduced in the ½ inch gap FIG. 4 between the screens.

This arrangement allows large amounts of manure to be washed on a continuous basis without any moving parts. In addition, the “bed depth” of the manure is kept very small and the bed flow surface area very high. This combines to yield low wash fluid flow velocities. The low fluid velocity prevents blinding of the wash module and provides high yields and high washing efficiency. Fluid flow velocity is proportional to the flow distance through the bed (“bed depth”) times the volume flow per unit time divided by the surface of area of the collector cylinder pairs (bed flow cross sectional area). For example, a conventional wash column maybe 8 ft. tall and have a bed cross-section area of 50 square ft. and volume flow of 8 cubic ft. per minute. The fluid velocity would be 0.16 ft/minute. My new wash module of the same dimensions would have an area of 1,920 square feet and bed travel distance of 0.33 ft. to yield a fluid velocity of 0.004 ft/minute.

Compaction tendency increases as the pressure drop across the bed increases. As the fluid velocity increases, the pressure drop increases as the bed depth increases. The pressure drop across the bed doubles when the bed depth doubles. Just based upon depth alone, the pressure drop across the wash module is 24 times less than a conventional wash column.

Flow rate through a given bed volume and pressure drop across the bed media is inversely proportional to the bed depth and varies with the square of the bed cross-sectional area. The wash module has a depth 24 times less and a bed area 38.4 times more than a conventional column bed. One would predict a flow increase of 35,000 fold over the prior art.

The washing efficiency increases as the wash fluid flow velocity through the media (manure) decreases. The wash module has a flow velocity 47 times less than the prior art.

I have found that corrugating the input and output pairs of screens such that the brine must travel in a corkscrew fashion is preferable. This prevents the brine from taking a short cut through the top of the manure bed; which would result in very little wash flow near the bottom of the wash module. This increases the flow path and promotes a more uniform washing action.

If the wash water was introduced across the whole input screen, the water washed only the upper portion of the manure. However, if I blocked the upper two-thirds of the wash module input screen and introduced the input water at the lower third, the flow across the manure was significantly more uniform. Similarly if the brine from the output was removed from the bottom third, the uniformity of washing was improved even more. See FIG. 5, brackets E-E.

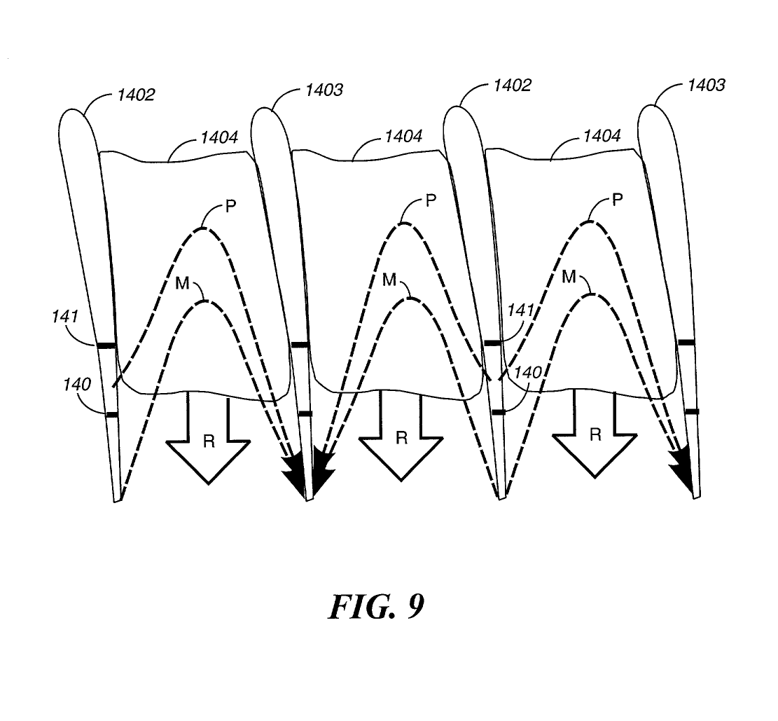

I also discovered that solids can pack over time; which can cause the wash module to become blocked. In order to prevent this from occurring, I taper the wash module screen pairs. See FIG. 9. That figure shows in cross section a number of screen pairs. The input screen pairs are 1402. Fresh water is introduced at the bottom one-third and preferably one-sixth of the screen pair. The liquid coming back from the centrifuge is known as centrate. This is also introduced in the lower ⅓ of the input screen 1402. Partitions 140 and 141 on a horizontal plane through the input pairs provide a means to prevent the fresh water introduction from being immediately mixed with the centrate introduction.

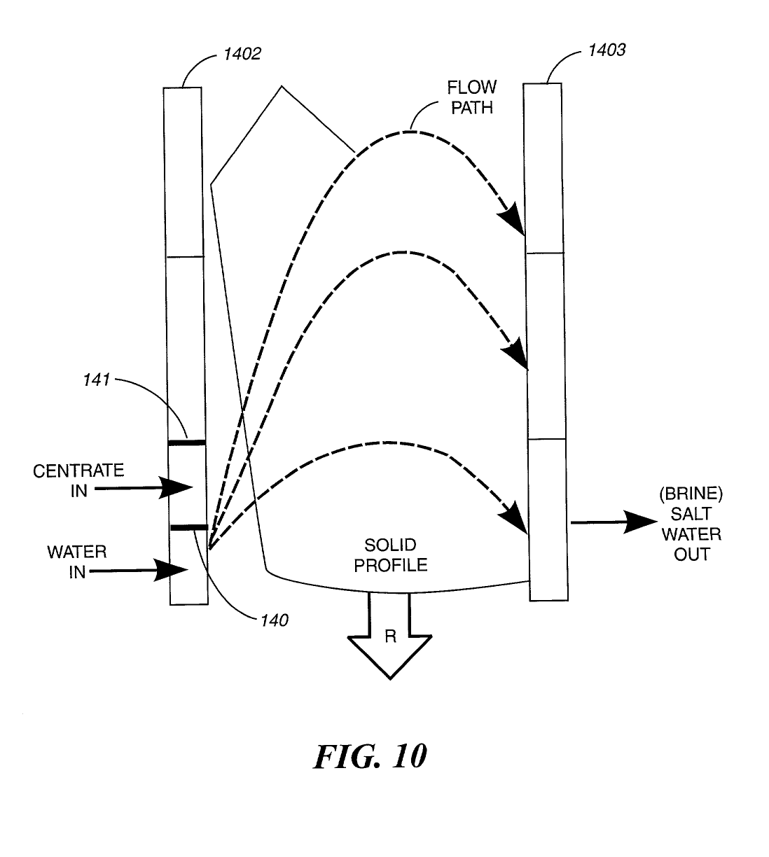

Washing proceeds, as shown diagrammatically in FIG. 10. This shows, in part, a phenomenon which I discovered by use of a dye (shown by the flow path arrows). FIG. 10 shows the solid profile and the washing profile.

The salt water brine is removed in the output collector pairs 1403.

The semi solid washed manure slurry 1404 is removed in the direction of the large arrow R. As more graphically illustrated in FIG. 9, it will be noted that the space between the pairs 1402 and 1403 is wider at the bottom than it is at the top. Thus, as the manure is progressing downwardly, it constantly expands outwardly. This prevents packing of the solids exiting the lower section of the wash module into the cone 90.

The curves M show the fresh water input flow through the manure slurry and out through the output pair 1403. The curves P show the centrate input liquid flow path to the collector output 1403. FIG. 9. As illustrated in FIG. 2B, there are six such pairs.

If the cone 90 bottom is not sufficiently steep, a wiper bar maybe needed to prevent the cone section, FIG. 1, at the bottom of the wash module from clogging.

### Chemical Methods

The following describes the role of salts and polymers with respect to sodium removal, washing permeability, dewatering effectiveness, and washing efficiency.

Nitrate ions are most preferably used to push off the sodium. They do not add to the salt burden of the soil and nitrate acts as a fertilizer for the plants.

Essentially the addition of iron, calcium (or/and magnesium) salts, and a high molecular weight, high charge cationic polymer work in a synergistic manner to push the sodium off the manure, and dramatically increase the flow of wash water through the manure.

The cattle manure can be coagulated with ferric salts, such as ferric nitrate, followed by the addition of a high molecular weight cationic polymer.

The ferric nitrate achieves the following:

it precipitates the phosphates to form iron phosphate;

it deactivates the naturally occurring emulsifiers;

it reduces the pH of the manure from 9.2 to 6.5 which is the preferred plant grown pH;

it pushes sodium off the manure by reducing the pH and having iron compete for the same manure sites that sodium is associated with;

The polymer synergistically works with the ferric nitrate to produce the following benefits:

the remaining suspended solids are coagulated; and

the permeability of manure solids is increased; which allows for quicker washing of the manure solids.

However, I have found that there are the following undesirable aspects of using iron salts:

1. Iron salts tend to be rather expensive compared to bulk fertilizers;

2. Iron salts come from steel pickling or circuit board etching operations; hence they are frequently contaminated with lead, copper, zinc, cadmium, and a host of other toxic metals. These contaminates detract from the value of the product;

3. Iron salts add little value to the product; thus little of the chemical cost can be recovered;

4. Iron salts tie up phosphate, making it less available to plants; and

5. Iron salts do little in terms of reducing the level of pathogens in the manure.

In view of these deficiencies, I prefer using nitric acid; which is a major chemical ingredient used in the fertilizer industry to make ammonium nitrate. The benefits of using nitric acid are:

1. All of the value of nitric acid is recovered from the enhanced value of the manure and manure tea as fertilizer;

2. 100% of the nitric acid is ultimately used by the plants;

3. It increases the availability of phosphate and other nutrients contained within the manure;

4. It reduces the amount of boron tied to the manure solids. As the level of boron decreases, the value of the manure solids increases dramatically because boron is very toxic to plants;

5. The resulting manure tea is more balanced in terms of ammonia, nitrate, phosphate, and potassium than the iron processed manure;

6. The nitric acid dramatically reduces the pH of the manure to 1.5. This kills many pathogens. Over time, the manure pH increases to a pH of 6.5; which is ideal for plant growth;

7. The manure tea also has a low pH of 2.5; which preserves the manure tea until it is ready for application; and

8. A further advantage is high sodium and chloride removal.

The nitric acid can be used alone or in conjunction with a polymer to enhance wash flow.

The ferric salt must be added before the addition of polymer, in order for the polymer to be effective. The polymer must be mixed in very gently to preserve the permeability of the manure. Once the polymer is mixed in, no additional shear need be placed on the manure before it leaves the wash module. The reactor module is designed such that manure solids drop from section to section via gravity to minimize shear.

Perforated metal screens separate the ferric salt addition section, polymer addition section and the wash module. The screens insure the proper amount of retention time in each section, while keeping shear to a minimum. The screens also insure uniform distribution of the manure solids in each section.

The chemically treated manure is easily washed with water as long as the bed depth is kept small and the velocity of the wash water is kept low. As these two variables increase, the manure compacts and closes off any additional flow water through the manure. If a counter-flow of wash water progressing from the bottom of the bed to the top of the bed is used to counteract the compaction problem due to gravity and flow, the manure bed channels. In this case, some portions of the manure are washed and other portions are not washed at all.

If the bed is agitated in any way, the washing efficiency gained by counter-current flow is lost.

In order to distinguish this new technology from cross-flow filtration, I am defining it as orthogonal flow washing.

The wash module consists of opposing sets of concentric screen pair cylinders. The unwashed manure slurry is introduced at the top and between two sets of screen pairs. As the manure slurry is washed, it progresses from the top to the bottom of the wash module via gravity. The wash water exits from input set of screen pairs through the manure and is collected by the waste brine water collector set of screen pairs. The wash water progresses by orthogonal flow through the manure solids. This arrangement allows the manure solids to be washed without disturbing the solids and with no moving parts in the wash module.

This arrangement also allows the travel distance of the wash water through manure to be very short. Since the travel distance of the wash water is short, the velocity of the wash water is low, which in turn minimizes compaction of the manure due to washing. In addition, the wash water flow is orthogonal to gravity, further minimizing the tendency to compaction.

The manure solids progress downward through wash module due to gravity; which insures a uniform progression of solids throughout the wash module.

The following compares the flow characteristics of a traditional counter-current flow to my orthogonal flow wash module:

| | Counter Current | Orthogonal |
|---|---|---|
| Wash module dimensions | 8 ft. diameter by 8 ft. tall | same |
| Wash module volume | 402 cu ft | same |
| Wash module residence time | 40 minutes | same |
| Production rate tons/hour | 10 cu ft/mm | same |
| Bed “depth” | 96″ | 4″ |
| Wash water velocity | 2.4″/min | 0.1″/min |
| Wash filter area | 50 sq. ft. | 1,200 sq ft |
| Relative wash flow rate for | | |
| a given wash pressure | | |
| From bed depth consideration | 1 | 24 |
| From bed area consideration | 1 | 576 |
| Combined effect | 1 | 13.824 |

According to Perry's Chemical Engineer's Handbook, the wash rate varies as the square of the bed area and inversely with the bed depth.

### Process Control

The amount of iron salt introduction is controlled by a pH probe, which senses the pH of the central water. If the pH is less than 6, the amount of iron salt is reduced and if the pH is greater than 6.5, the amount of iron salt is increased.

The amount of polymer introduced is controlled by pressure sensors that measure the pressure drop between the input collector and the waste brine collector of the wash module. If the pressure drop is too high, the amount of polymer is increased.

The amount of fresh make up water introduced is controlled by a conductivity meter, which measures the amount of TDS in the concentrate. If the TDS is too high, the fresh make up flow is increased.

### Process Performance

Many of these tests were run without knowing the exact composition of the manure. Some of the manure processed has as much as 70% clay; with the balance being manure. My process can tolerate high levels of clay. As the percentage of manure increases, the amount of ferric nitrate or nitric acid required for complete coagulation increases.

TDS removal is strictly a function of wash water volume and residence time. As these two factors increase, the amount of TDS removal increases. Sodium removal is a little more complex. It requires lowering the pH of the manure and metal ion such as iron to compete for the sites that the sodium is attached to.

According to Perry's Chemical Engineering Handbook, the process approaches the practical limit of removing salt by washing. Consider these results:

Cattle manure is 63% clay, 27% manure.

Fresh dry lot manure is 60% organic matter.

The estimated value of extracted manure is over $20.00 per ton.

Waste brine can be fortified with nitrate and phosphate and sold as manure tea without evaporating the water.

97% of the chloride is removed. 91% of the sodium is removed.

The copper content is reduced 70%. The boron is reduced 42%.

The experiments demonstrated that two valuable products can be produced by washing cattle manure. The manure solids were washed to the point of reducing sodium and chloride down to acceptable levels. It has been estimated that the value of the manure solids is $23 per cubic yard or $20/ton.

In addition, the salt brine (“manure tea”) has value as a fertilizer without removing the water. This means we will not need to use a brine tunnel or evaporation ponds. When the brine is diluted to produce the ideal potassium concentration of 150 PPM, the sodium level is reduced to 30 PPM (anything below 100 PPM is acceptable) and chloride is reduced to 13 PPM (anything below 150 PPM is acceptable).

Sulfur level of the manure tea is 45 PPM when applied at the proper dilution (anything below 800 PPM is acceptable).

The manure tea may be fortified with additional nitrate and phosphate to produce a perfectly balanced manure tea. I can achieve this by substituting some of the iron sulfate with iron nitrate. Most of the iron nitrate expense would be recovered by the increased value of the manure tea. The reduction of iron sulfate use would also reduce sulfate levels in the manure tea. The phosphate level could be increased by adding calcium phosphate (phosphate rock) to the manure tea. This would produce calcium sulfate (gypsum) and soluble phosphate salt. This addition would reduce sulfate levels even more.

I theorize that iron nitrate may be used to bring the manure tea into balance.

I theorize that the concentration of iron salts used for manure processing is a key factor in removing the sodium and chloride iron from the manure.

I have processed manure under the following processing conditions:

1 ton 50% moisture manure

180 pounds iron sulfate (added as a 50% brine solution)

3 pounds K260 FL high cationic charge, high molecular weight polymer (added as 0.5% solution)

1.8 tons of water added to form slurry

1.6 tons of waste brine generated

Wash time 10 to 15 minutes

COMPARISON OF TREATMENTS

| Coagulant A | Ferric Chloride | Ferric Sulfate | Ferric Sulfate | Ferric Chloride |
|---|---|---|---|---|
| Amount | 4% | 2% | 4% | 1% |
| Coagulant B | None | K280 FL | K280 FL | K280 FL |
| Amount | | 5 ml of 1% | 10 ml of 0.5% | 10 ml of 0.5% |
| Wash Volume | 150 ml | 130 ml | 150 ml | 150 ml |
| Wash Time | 40 minutes | 3.5 minutes | 14 minutes | 5.5 minutes |
| Washed Manure | | | | |
| % Sodium | 0.1260 | 0.260 | 0.260 | 0.30 |
| % reduction | 79% | 57% | 57% | 50% |
| TDS in PPM | 2,680 | 2,900 | 1,149 | 1,052 |
| % TDS reduction | 87% | 85% | 94% | 95% |
| Cycle Number | 3 | 6 | 8 | 7 |
| % Moisture | 70% | 59.0% | 58.4% | |

High Wash Manure used
All tests done on 50 grams of cattle manure. Amount of Coagulant B based on % weight of wet
cattle manure

| | | | | | |
|---|---|---|---|---|---|
| Coagulant A | Ferric Sulfate | Ferric Sulfate | Ferric Sulfate | Control | Nitric aid |
| Amount | 1% | 1.5% | 2% | | 3.5% |
| Coagulant B | Magnesium | Calcium | Sulfuric Acid | | |
| | Sulfate | Sulfate | | | |
| | 1% | 0.75% | 0.35% | | |
| Coagulant C | K280 FL 0.5% | K280 FL 0.5% | K280 FL 0.5% | | Optimer 7194 0.5% |
| Amount | 10 ml | 10 ml | 10 ml | | 3 ml |
| Wash Volume | 150 ml | 130 ml | 150 ml | | 160 ml |
| Wash Time | 9.5 minutes | 19 minutes | 5.3 minutes | | |
| Washed Manure | | | | | |
| % sodium | 0.30 | 0.30 | 0.34 | 0.62 | 0.092 |
| TDS in PPM | 709 | 1,200 | 1,200 | 20,000 | 1,900 |
| % TDS reduction | 96% | 94% | 94% | | 94% |
| Cycle Number | 3 | 3 | 4 | | 5 |
| % Moisture | 40.8% | 38.9% | 28.2% | | 66% |
| High Wash Manure | | | | | |
| Coagulant A | Sulfuric Acid | Sulfuric Acid | | | |
| Amount | 0.7% | 1.75% | | | |
| Coagulant B | | | | | |
| Coagulant C | K280 FL 0.5% | K280 FL 0.5% | | | |
| Amount | 12.5 ml | 10 ml | | | |
| Wash Volume | 150 ml | 150 ml | | | |
| Wash Time | 6.5 min | 17 min | | | |
| Washed Manure | 0.28 | | | | |
| % Sodium | | | | | |
| TDS in PPM | 660 | 1,890 | | | |
| % TDS reduction | 96% | 90% | | | |
| Cycle Number | 3 | 5 | | | |
| % Moisture | 56.5% | | | | |
| pH | | 6 | | | |
| High wash manure | | | | | |

All tests done on 50 grams of cattle manure. Amount of Coagulant B based on % weight of wet
cattle manure.

The sulfuric acid/ferric sulfate should give the best sodium removal.

TDS means amount of totally dissolved solids in water. It usually correlates with conductivity in the case of salts.

Low wash manure used in these tests:

| Coagulant A | Ferric Chloride | Iron Sulfate | Control |
|---|---|---|---|
| Amount | 6% | 9% | |
| Coagulant B | K260 FL 0.5% | K260 FL 0.5% | |
| Amount | 6 ml | 13 ml | |
| Wash Volume | 170 ml | 170 ml | |
| Wash Time* | 20 min | 26 min | |
| Washed Manure | | | |
| % Total Sodium 0.867% | 0.10 | 0.092 | |
| % Reduction | 88% | 89% | |
| Leachable Sodium PPM | 108 | 116 | 1,307 |
| % reduction | 92% | 91% | |
| % Leachable Chloride | 231 | 99 | 3,239 |
| % reduction | 93% | 97% | |
| Leachable TDS PPM | 1,971 | 3,814 | 14,659 |
| % TDS reduction | 86% | 73% | |
| Cycle number | 8 | 3 | |
| % Moisture | 56 | 62 | 48 |
| pH | 8.25 | 6.51 | 9.35 |
| % Total Nitrogen | 0.81 | 1.31 | 2.24 |
| % Organic Matter | 47 | 61 | 55 |

*Wash time can be dramatically reduced by small increases in polymer addition.

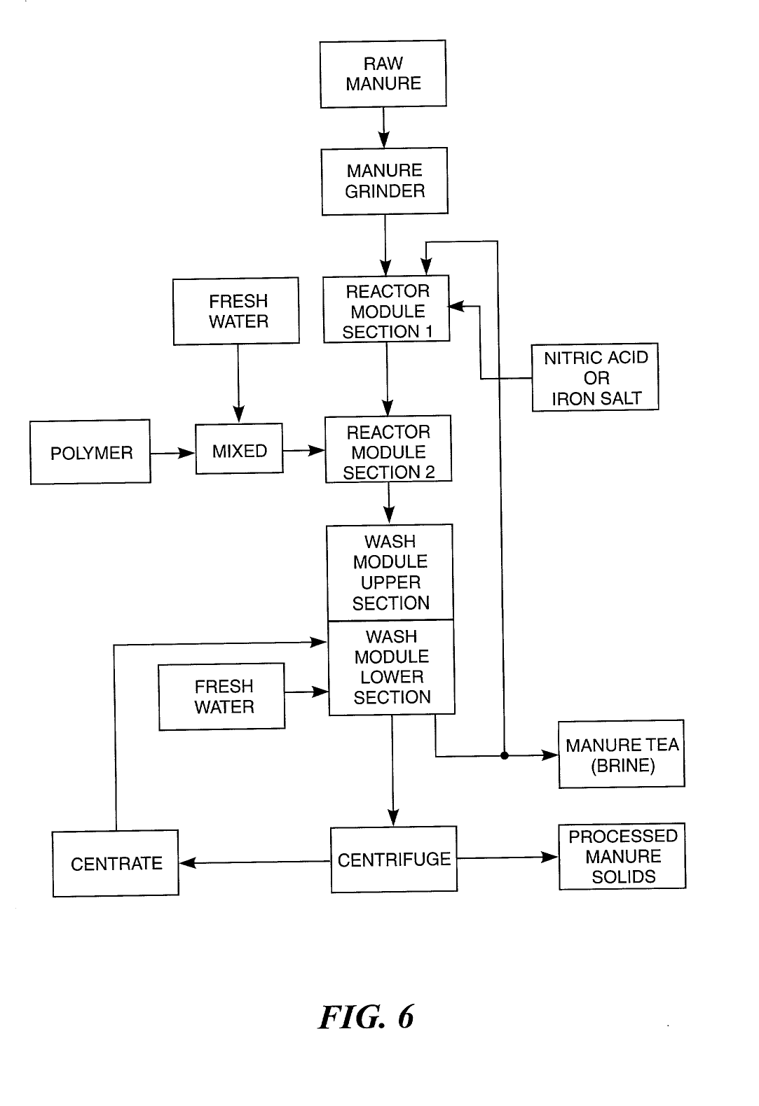

The preferred process is shown in the flow chart FIG. 6. Raw manure is screened and then ground into one quarter inch particles. It is fed by gravity onto the surface of a liquid into a reactor mixing module first section, where it is mixed with the liquid composed of brine and nitric acid. It exits by gravity through a perforated metal plate. Then it is mixed with a mixture of water and polymer. Next it flows into the top of a wash module section. Added near the bottom is semi-salted water from a centrifuge. Fresh water is added to the bottom of the wash section. The mixture progresses by gravity to the bottom of the wash section. The fluid introduced into the wash module migrates orthogonally to the output screen pair in the tank. Brine is drawn off near the bottom of the output screen pair and returned to the first section of the reactor mixing module to provide moisture to the raw manure. Some of this brine is collected as a manure tea by-product. The washed manure exits the bottom of the wash module and is pumped into a centrifuge; where the solids are separated from the liquid and collected. The liquid is pumped back into wash module.

1. A method of washing manure to remove undesirable elements and produce environmentally desirable processed manure solids, comprising the steps of:
a. pulverizing the manure;
b. mixing the pulverized manure with a liquid comprising at least nitric acid and a polymer, to form a slurry;
c. washing the slurry with brine and water to remove environmentally objectionable levels of salt;
d. collecting and centrifuging the washed slurry; and
e. collecting processed manure solids from the centrifuging process.

2. A method of washing manure to remove undesirable elements and produce environmentally desirable process manure solids as set forth in claim 1, comprising the additional steps of:
a. performing at least the steps b. through d. of claim 1 by using gravity to move the manure.

3. The method of claim 1 wherein the washing of the manure proceeds by passing the brine and water through the manure in an orthogonal flow.

4. The method of claim 1 wherein the additional step of collecting the liquid from the centrifuge and using it as the brine introduced in the washing process.

5. The method of claim 1 wherein the additional step of collecting the liquid from the centrifuge and using it as a by-product for agricultural purposes.

6. The method of claim 1 wherein the additional step of removing brine from the washing process and introducing it as part of the liquid mixture with the nitric acid and polymer.

7. The method of claim 1 wherein the polymer is first mixed with water in a ratio of approximately one part polymer to 99 parts water.

8. An apparatus for washing manure to remove undesirable elements and produce environmentally desirable processed manure solids, comprising:
a. pulverizing means to pulverize the manure;
b. mixing means to mix the pulverized manure with a liquid comprising at least nitric acid and a polymer, to form a slurry;
c. washing means to wash the slurry with brine and water to remove environmentally objectionable levels of salt from it;
d. collecting means to collect the washed slurry;
e. centrifuging means to centrifuge said washed slurry and produce processed solids and liquid by-product; and
f. collecting means to collect the processed manure solids from the centrifuging process.

9. An apparatus as set forth in claim 8, comprising:
a. an arrangement of the means set forth in elements a., b., c. and d. so that the manure and slurry passes therethrough by gravity.

10. An apparatus as set forth in claim 8 wherein the washing means has means for passing the brine and water through the slurry in an orthogonal flow.

11. An apparatus as set forth in claim 8 wherein removal means are provided for removing brine from the washing means and introducing it as part of the liquid having the nitric acid and polymer.

12. An apparatus as set forth in claim 8 wherein polymer mixing means are provided to mix the polymer with water in a ratio of approximately one part polymer to 99 parts water and supply it to the mixing means of element b.

13. An apparatus as set forth in claim 8 wherein return means are provided to return a portion of the liquid by-product produced by the centrifuging means of element e., to the washing means of element c.

14. An apparatus as in claim 8 wherein fresh water means is provided to introduce fresh water into the washing means of element c.

15. An apparatus as in claim 8 wherein said washing means of element c. comprises a container having a plurality of screen pairs therein.

16. An apparatus as in claim 15 wherein the screen pairs comprise envelopes and said pairs are so spaced that slurry may be introduced between the pairs for washing of the slurry.

17. An apparatus as in claim 16 wherein the screen pair envelopes have vertically extending faces arranged such that the uppermost portions thereof are spaced closer to each other than the lower portions thereof.

18. An apparatus as in claim 15 wherein the screen pair envelopes have vertically extending spaced apart faces and between said faces are horizontally extending partitions.

19. An apparatus as in claim 18 wherein the fresh water means communicates with the lower third of at least some screen pairs to introduce the fresh water.

20. An apparatus as in claim 19 wherein the means for passing the brine and water is connected to the washing means and screen pair envelopes in such a manner that the brine passes through the envelope above a partition and the water passes through the envelope below that partition.
